(19) United States
(12) Patent Application Publication
(10) Pub. No.: US 2005/0057505 A1
(43) Pub. Date: Mar. 17, 2005

(54) Mouse

(75) Inventors: Hiroaki Akiyama, Osaka (JP); Tsuyoshi Watanabe, Osaka (JP); Satoshi Nakagawa, Tokyo (JP)

Correspondence Address: BANNER & WITCOFF, 1001 G STREET N W, SUITE 1100, WASHINGTON, DC, 20001, US

(73) Assignee: Kokuyo Co., Ltd., Osaka (JP)

(21) Appl. No.: 10/651,085

(22) Filed: Aug. 29, 2003

(51) Int. Cl. G09G 5/08

(52) U.S. Cl. 345/163

(57) ABSTRACT

A space S into which a finger of an operator can be inserted is arranged under buttons 11, 12 as an input operating portion of a mouse M that is used as a pointing device for an information processing unit such as a personal computer in order to make it possible to operate the mouse naturally irrespective of a size of a hand.

### FIELD OF THE INVENTION

This invention relates to a mouse used as a pointing device for an information processing unit such as a personal computer.

### BACKGROUND OF THE INVENTION

Conventionally a mouse used as a pointing device for a personal computer is a general semiellipse in a side view and used with making its bottom face contact with an upper face of a top plate.

When using a mouse having the above shape, whole of the mouse is slightly gripped with keeping fingers usually stretched and a button is pushed with keeping the fingers stretched.

However, in accordance with the mouse having the above shape, it might be difficult for a small hand to put a finger on the button naturally with keeping the mouse slightly gripped.

It is considered to be effective to downsize the mouse in order just to simply avoid the above problem. However, it is not good for a person with a big hand if the mouse is downsized because a length of a finger will be too long to grip the mouse slightly and to put the finger on the button. This may cause a problem that the finger has to be folded unnaturally in order to put the finger on the button.

### SUMMARY OF THE INVENTION

The present claimed invention is to solve the above-mentioned problems and discloses an arrangement of a mouse that can be operated in a more natural posture irrespective of a size of a hand.

A mouse in accordance with the present claimed invention is used as a pointing device for an information processing unit such as a personal computer and is characterized by that a space into which an operator can insert his or her finger is arranged under a button as an input operating portion.

In accordance with the arrangement, a size of the body can be so made that a person with a small hand can operate the mouse with keeping his or her hand put on the button with ease and that a person with a big hand can operate the mouse with keeping his or her finger put on the button and an extra portion of the finger put into the space, which makes it possible to operate the mouse comfortably irrespective of a size of the hand of the operator.

Further, if the button can be operated with a pulling movement of the finger, it is possible to operate the button with keeping the finger put on the button and the extra portion of the finger put into the space without replacing the finger. As a result, the mouse can be operated with ease irrespective of a size of a hand.

As a concrete embodiment of the mouse represented is that a projecting portion is arranged on an upper portion to project forward and generally horizontally and the projecting portion is so formed to have the button at a distal end portion thereof.

In addition, as a concrete embodiment of the mouse wherein the button can be pushed with the pulling movement of the finger represented is that a face of the button to receive an operational force faces at least forward. In accordance with the arrangement, the button can be pushed down toward the operator by an operational force from the forward. The term “a face to receive an operational force faces at least forward” here is a concept including a whole meaning that the button goes under when an operational force from the forward is applied to the button.

Further, in order to make the button go under when an operational force is applied to the button from the front and the upward it is preferable that the face of the button to receive an operational force stands from the front lower edge portion of the projecting portion toward a rear upper direction.

In order to make it possible to operate the above-mentioned mouse comfortably it is preferable that a height of a fingertip locates between an upper surface of the top plate and an upper edge of the button with keeping a condition that a standard body-built person puts his or her finger on the button. In accordance with the arrangement, a fingertip will not touch the top plate when the finger is put on the button and the finger is pulled to operate the button.

In order to make it more comfortably to operate the mouse it is preferable that the front end portion of the projecting portion is in a tapered shape toward the front. In accordance with the arrangement, it is possible to put a finger of the operator on the button without stretching the finger by force.

In order to make it easy to grip the body of the mouse it may be so arranged that the space reaches a part under a proximal end portion of the projecting portion and a thumb and an annular finger or a pinkie are inserted into the space so that a lower portion of the body can be gripped with the thumb and the annular finger or the pinkie. In accordance with the arrangement it is possible to grip the mouse naturally from the back, front, right and left directions with the thumb and the annular finger or the pinkie.

In order to make it easy to move the mouse irrespective of a size of a hand it is preferable that a hand placing portion on which a hand can be put is arranged under the body having the button. In accordance with the arrangement, there is no need of gripping the mouse since the mouse can be moved with keeping the wrist or the hand put on the hand placing portion.

In the present claimed invention “forward” indicates a direction heading toward a fingertip of an operator who grips the mouse.

As mentioned above, since the mouse of the present claimed invention has the space into which the finger can be inserted under the button as the input operating portion, it is possible to set a size of the body so that even an operator with a small hand can put his or her finger on the buttons with keeping the body gripped easily and that an operator with a big hand can insert an excessive part of his or her finger into the space when operating the buttons. As a result, the mouse can be operated comfortably by anyone regardless of a size of the hand.

### BRIEF DESCRIPTION OF THE DRAWINGS

FIG. 1 is a perspective view of a mouse in accordance with one embodiment of the present claimed invention.

FIG. 2 is a plane view of the mouse in accordance with the embodiment.

FIG. 3 is a side view of the mouse in accordance with the embodiment.

FIG. 4 is a front view of the mouse in accordance with the embodiment.

FIG. 5 is a back view of the mouse in accordance with the embodiment.

FIG. 6 is a bottom view of the mouse in accordance with the embodiment.

FIG. 7 is a longitudinally cross-sectional view showing a state of a hand placing portion in FIG. 4.

FIG. 8 is a view showing a state of using the mouse in accordance with the embodiment.

### DETAILED DESCRIPTION OF THE PREFERRED EMBODIMENTS

An embodiment of the present claimed invention will be described in detail with reference to the accompanying drawings.

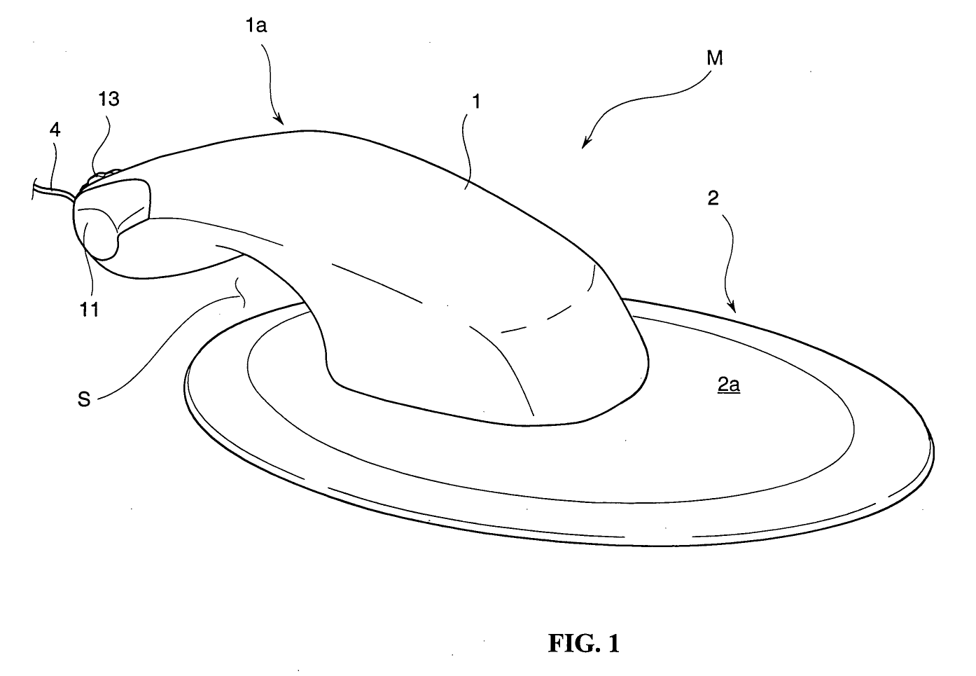

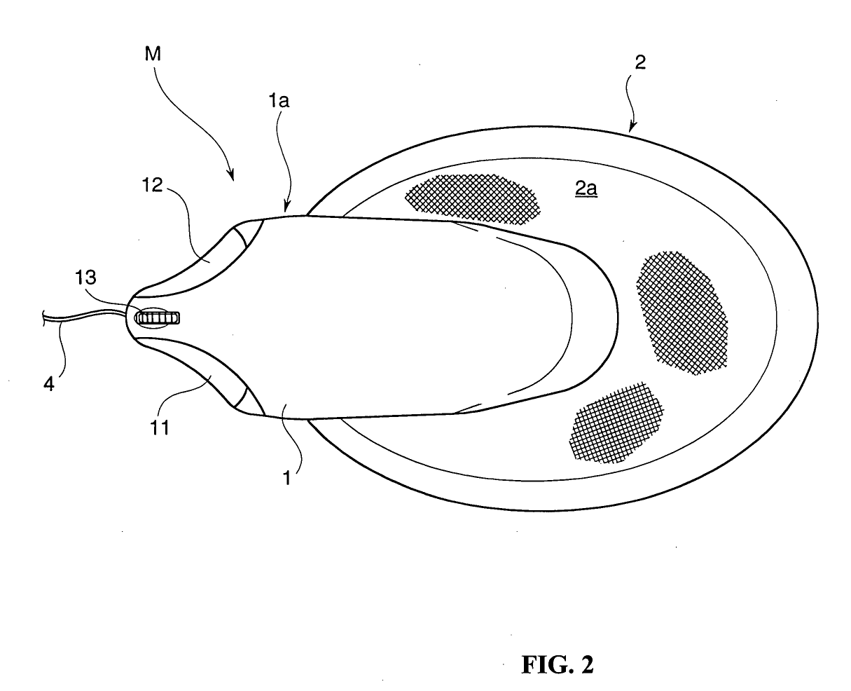

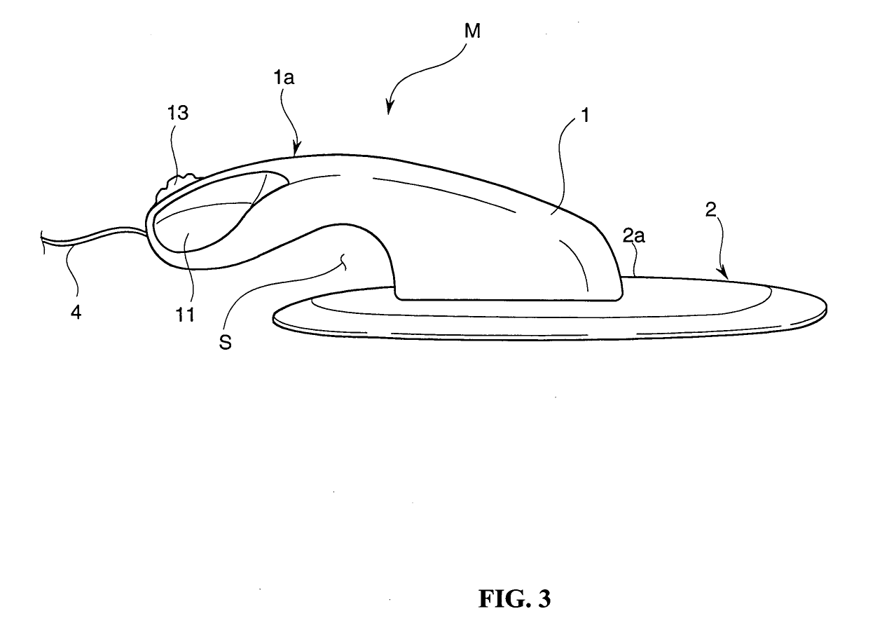

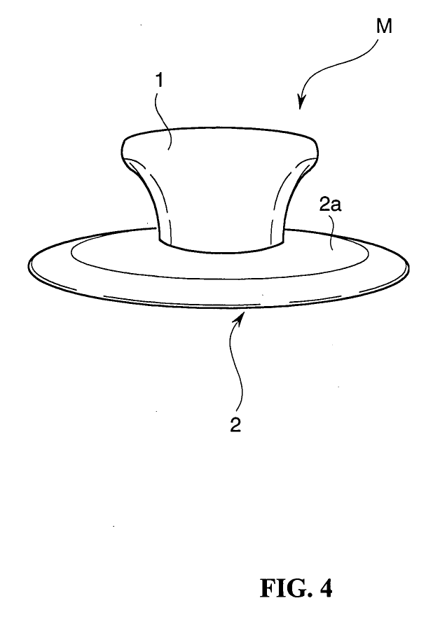

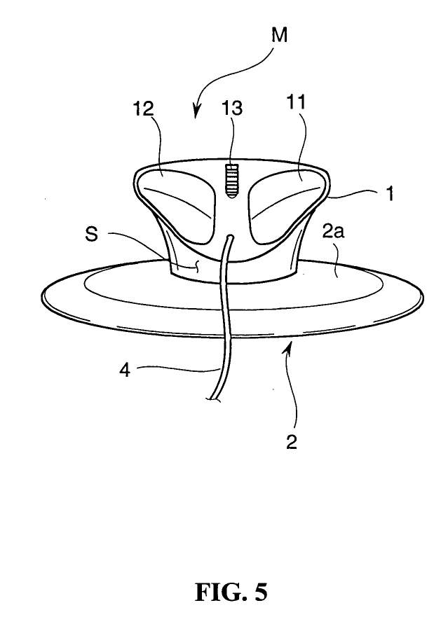

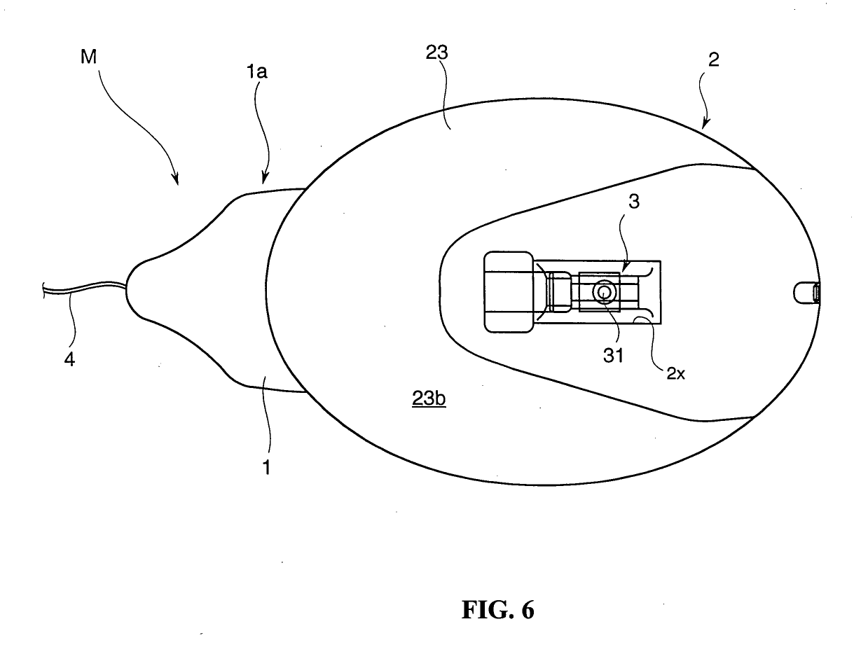

A mouse M in accordance with the embodiment, whose perspective is shown in FIG. 1, whose plane view is shown FIG. 2, whose side view is shown in FIG. 3, whose front view is shown in FIG. 4, whose back view is shown in FIG. 5 and whose bottom view is shown in FIG. 6, comprises a body 1 that has buttons 11, 12 as an input operating portion and a wheel 13 at its front portion, a hand placing portion 2 in a shape of a sheet extending back and forth and right and left from a bottom end portion of the body 1, a traveling direction detecting portion 3 that optically scans a traveling direction of the mouse M and a cable 4 to connect the mouse M with an information processing unit, not shown in drawings. The front here means a direction heading an operator. FIG. 1 through FIG. 6 are generally full-sized.

More concretely, as shown in FIG. 1, FIG. 2 and FIG. 3, the body 1 is arranged to stand from a general center of the hand placing portion 2 in an elliptical shape of a sheet and a projecting portion 1a is arranged to project forward from an upper portion of the body 1. As shown in FIG. 1, FIG. 2 and FIG. 5, the wheel 13 is arranged at a center of a width direction of the front end portion of the projecting portion 1a and the buttons 11, 12 are arranged right and left across the wheel 13.

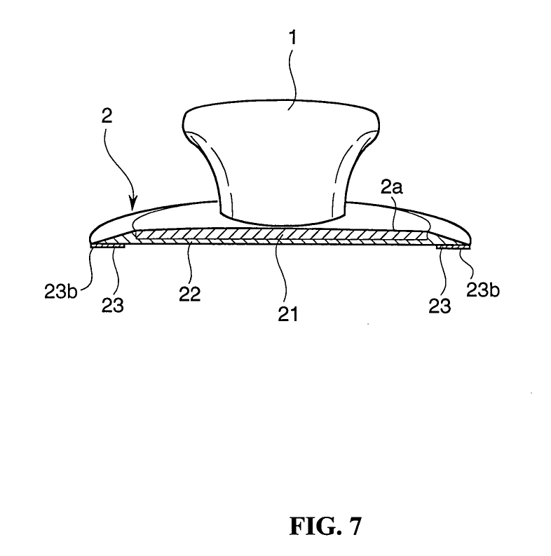

The hand placing portion 2 has, as shown in FIG. 6 and FIG. 7 in which a longitudinally cross-sectional view of a part of the hand placing portion 2 shown in FIG. 4 is shown, a soft layer 21 made of a soft material, urethane in this embodiment, and a core layer 22 made of a more rigid material. In addition, a hand placing face 2a as a face to be touched by a hand comprises the soft layer 21 and the core layer 22 is arranged under the soft layer 21 and at both sides of the soft layer 21. An opening portion 2×that opens downward is arranged at a general center of the hand placing portion 2 and the traveling direction detecting portion 3 is arranged above the opening portion 2×as will be described later. Further, in this embodiment a sliding portion 23 made of a skiddy material, tetrafluoroethylene resin in this embodiment, is arranged under the core layer 22 at the front and both sides of the opening portion 2x. The hand placing portion 2 is used with keeping a bottom surface 23b of the sliding portion 23 put on an upper surface of a top plate of a desk or the like.

The traveling direction detecting portion 3 comprises, as shown in FIG. 6, a traveling direction detecting portion body 31 arranged above the opening portion 2x of the hand placing portion 2 inside the body 1 and a traveling direction calculating circuit, not shown in drawings, arranged inside the body 1 and in this embodiment the traveling direction detecting portion 3 has the same arrangement as that of a well-known mouse as an optical mouse. More specifically, the traveling direction detecting portion body 31 comprises a CMOS image sensor and it detects an image of the top plate, a traveling direction of the mouse M is calculated by the traveling direction calculating circuit and then the traveling direction of the mouse M is sent to the connected information processing unit, not shown in drawings.

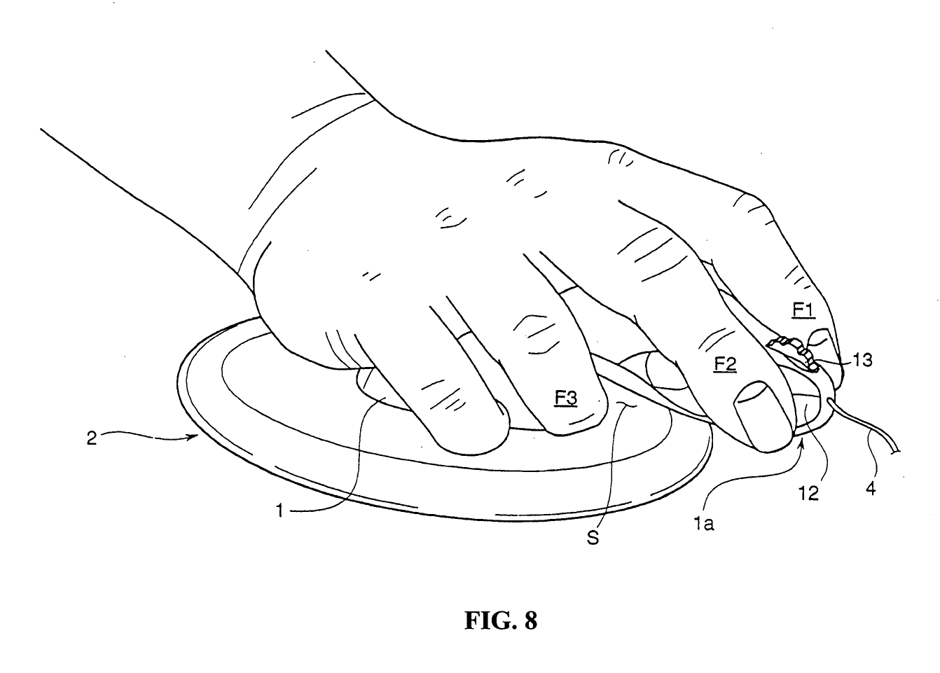

The mouse M having the above arrangement is used, as shown in FIG. 8, in a posture that an index finger F1 and a middle finger F2 of the operator are placed on the buttons 11 and 12 and a lower portion of the body 1 is gripped with a thumb (omitted to show in drawings) and an annular finger F3 of the operator with keeping a wrist put on the hand placing portion 2. The mouse M is moved by moving the hand horizontally with the above condition kept.

As shown in FIG. 1, FIG. 3, FIG. 5 and FIG. 8, a space S is formed under the projecting portion 1a having the buttons 11 and 12 to insert a finger. The buttons 11 and 12 can be operated with the index finger F1 and the middle finger F2 pushed downward or pulled forward. The front end portion of the projecting portion 1a is tapered toward the forward.

More concretely, the buttons 11, 12 are so arranged that each of its lower end locates at a front lower edge portion of the projecting portion 1a and a face to receive an operating force stands from the front lower edge portion of the projecting portion 1a toward a rear upper direction and faces a front upper side direction. When the index finger F1 or the middle finger F2 is pulled toward the operator so as to operate the buttons 11, 12, each distal end portion of the fingers F1 and F2 moves toward the operator in the space S. The space S reaches under a proximal end portion of the projecting portion 1a so that the thumb and the annular finger F3 are inserted into the space S and the lower portion of the body 1 can be gripped with the thumb and the annular finger F3 from the back, front, right and left directions.

Further, the mouse M can be moved with keeping the hand put on the hand placing portion 2 and the wrist, an outer portion of the thumb and an outer portion of the pinkie can be placed on the hand placing portion 2.

In accordance with this arrangement, since a size of the body 1 is so set that even an operator with a small hand can put his or her index finger F1 and middle finger F2 on the buttons 11, 12 with keeping the body 1 gripped and that an operator with a big hand can insert an excessive part of his or her finger into the space S when operating the buttons 11, 12, it is possible for anyone to operate the mouse M comfortably regardless of a size of the hand.

In addition, since the buttons 11, 12 can be operated by pulling the finger toward the operator, it is possible to operate the mouse M with ease with keeping the finger inserted into the space S.

Further, since the face of the buttons 11, 12 to receive the operating force is arranged to face a front upper direction, the face of the buttons 11, 12 to receive the operating force goes under due to the operating force from the front direction when the finger is pulled, thereby to operate the buttons 11, 12 naturally by pulling the finger.

Since the projecting portion 1a of the body 1 is tapered toward the forward and the buttons 11, 12 and the wheel 13 are arranged at the front, it is possible to operate the buttons 11, 12 and the wheel 13 with positioning the finger at a desired position.

Further, since the hand placing portion 2 is arranged under the body 1, it is possible to move the mouse M with keeping the wrist or the hand put on the placing portion 2, which makes it possible to move the mouse M even for a person who can not grip the body 1 because his or her hand is injured.

In addition, since the body 1 is arranged to stand from the sheet-shaped hand placing portion 2, an arrangement of the hand placing portion 2 can be simplified.

Further, since the hand placing face 2a is made of the soft material, the hand placing face 2a transforms itself by following a posture of the operator handling the mouse M and supports the hand with the hand placing face 2a irrespective of a posture of the operator handling the mouse M, which makes the mouse M user-friendly and soft to the touch. The hand placing portion 2 absorbs a load on the wrist, thereby to effectively prevent tendovaginitis or callus.

In addition, since the sliding portion 23 made of tetrafluoroethylene resin is arranged around the traveling direction detecting portion 3, it is possible to move the mouse M smoothly on the top plate.

The present claimed invention is not limited to the above-described embodiments.

For example, a shape of the body 1 may not be tapered toward the forward. It is possible to operate a mouse comfortably as far as a space is arranged under a button.

The hand placing portion may not be in a shape of a sheet. For example, it may be formed in a shape of a plate. Or a dent is arranged on a mouse to place a hand on so that an inner side of the dent constitutes the body and the dent constitutes the hand placing portion. The hand placing portion may be omitted.

Further, if the face of the button to receive the operational force faces upward, it is possible to operate the button by pulling the finger even though a shape of a body is different from the above-mentioned shape of the body 1. In addition, if the face of the button to receive the operational force does not face upward, the mouse can be operated comfortably irrespective of a size of a hand as far as a space is arranged under the button.

The space is not necessarily continuous from a part under the front end of the projecting portion to a part under the proximal end portion of the projecting portion. It is possible to grip a mouse with taking a natural posture as far as a space is arranged at a portion a thumb touches and a portion an index finger or a pinkie touches.

The button is not necessarily operated by a movement of pulling a finger. If a space is arranged under a button, it is possible operate a mouse comfortably irrespective of a size of a hand as far as the button is so arranged to be operated with a portion near a proximal end of a finger.

In addition, the traveling direction detecting portion may have the same arrangement as that of a well-known traveling direction detecting portion as a ball-type mouse.

The sliding portion may be made of a material other than tetrafluoroethylene resin and the sliding portion itself may be omitted.

Other component may be variously modified without departing from the spirit of the invention.

1. A mouse that is used as a pointing device for an information processing unit such as a personal computer with its bottom face making a contact with a top plate of a desk or the like and characterized by that a space into which the operator can insert his or her finger is arranged under a button as an input operating portion.

2. The mouse described in claim 1 and characterized by that the button can be operated with a pulling movement of the finger.

3. The mouse described in claim 1, and characterized by that a projecting portion is arranged on an upper portion to project forward and generally horizontally and the button is arranged at a distal end portion of the projecting portion.

4. The mouse described in claim 3, and characterized by that a face of the button to receive an operational force faces at least forward.

5. The mouse described in claim 4, and characterized by that the face of the button to receive the operational force stands from the front lower edge portion of the projecting portion toward a rear upper direction.

6. The mouse described in claim 3, and characterized by that a height of a fingertip locates between an upper surface of the top plate and an upper edge of the button with keeping a condition that a standard body-built person puts his or her finger on the button.

7. The mouse described in claim 3, and characterized by that the front end portion of the projecting portion is in a tapered shape toward the forward.

8. The mouse described in claim 1, and characterized by that the space reaches a part under a proximal end portion of the projecting portion and a thumb and an annular finger or a pinkie are inserted into the space so that a lower portion can be gripped.

9. The mouse described in claim 1, and characterized by that a hand placing portion is arranged under a body having the button.

10. The mouse described in claim 2, and characterized by that a projecting portion is arranged on an upper portion to project forward and generally horizontally and the button is arranged at a distal end portion of the projecting portion.

11. The mouse described in claim 10, and characterized by that a face of the button to receive an operational force faces at least forward.

12. The mouse described in claim 11, and characterized by that the face of the button to receive the operational force stands from the front lower edge portion of the projecting portion toward a rear upper direction.

13. The mouse described in claim 4, and characterized by that a height of a fingertip locates between an upper surface of the top plate and an upper edge of the button with keeping a condition that a standard body-built person puts his or her finger on the button.

14. The mouse described in claim 5, and characterized by that a height of a fingertip locates between an upper surface of the top plate and an upper edge of the button with keeping a condition that a standard body-built person puts his or her finger on the button.

15. The mouse described in claim 4, and characterized by that the front end portion of the projecting portion is in a tapered shape toward the forward.

16. The mouse described in claim 5, and characterized by that the front end portion of the projecting portion is in a tapered shape toward the forward.

17. The mouse described in claim 6, and characterized by that the front end portion of the projecting portion is in a tapered shape toward the forward.
